(19) United States
(12) Patent Application Publication
(10) Pub. No.: US 2016/0027354 A1
(43) Pub. Date: Jan. 28, 2016

(54) DISPLAY UNEVENNESS CORRECTION APPARATUS, DISPLAY APPARATUS, METHOD FOR CORRECTING DISPLAY UNEVENNESS, AN METHOD FOR MANUFACTURING THE DISPLAY APPARATUS

(71) Applicant: PANASONIC INTELLECTUAL PROPERTY MANAGEMENT CO., LTD., Osaka (JP)

(72) Inventors: Haruko TERAI, Osaka (JP); Kazuhiro FUNAMOTO, Hyogo (JP)

(21) Appl. No.: 14/438,788

(22) PCT Filed: Sep. 29, 2014
(86) PCT No.: PCT/JP2014/004959

§ 371 Date: Apr. 27, 2015

(30) Foreign Application Priority Data
Dec. 20, 2013 (JP) 2013-263443

(51) Int. Cl. G09G 3/00; G09G 3/36; G01J 1/44

(52) U.S. Cl. CPC G09G 3/006; G01J 1/44; G09G 3/3611; G01J 2001/4247

(57) ABSTRACT

A display unevenness correction apparatus for use in the manufacture of an LCD display including an LCD panel having display pixels arranged in rows and columns, the apparatus including: a luminance meter which measures a luminance of the LCD panel while the LCD panel is being illuminated to obtain a luminance; a block luminance calculation unit which segments the luminance map into first blocks and calculate, for each of the first blocks, a block luminance of the first block using luminances included in the first block, the block luminance representing the luminances included in the first block; an interpolation unit which calculates a target luminance for each of the display pixels, using a corresponding one of the block luminances; and a correction gain calculation unit which calculates a correction coefficient for each display pixel using the target luminance.

### TECHNICAL FIELD

The present disclosure relates to a display unevenness correction apparatus, a display apparatus, a method for correcting display unevenness, and a method for manufacturing the display apparatus.

### BACKGROUND ART

For example, a liquid crystal (LCD) display by way of example of display includes an LCD panel in which a plurality of display pixels (hereinafter variously, referred to as “cells”) are arranged in a matrix, backlights, such as light emitting diodes (LEDs), disposed on the back of the LCD panel, and a diffuser for diffusing light output from the individual LEDs. It is desirable from a standpoint of video quality that the LCD display adjusts luminances of the plurality of cells to be uniform if uniform tonal signals are input.

However, the luminance of the display panel may be un-uniform due to luminance unevenness attributed to cell performance or the like, luminance unevenness attributed to backlights, etc. The luminance unevenness attributed to backlights includes luminance unevenness which is attributed to a difference in performance of individual backlights, and luminance unevenness due to a fact that spaces between the diffuser and the backlights are narrowed because of a decreased thickness of the LCD display and this impedes sufficient diffusion of light from the backlights.

In a conventional LCD display, for example, a luminance of each of cells included in a display panel is measured and the luminances of the cells are corrected so as to be the same as the lowest luminance of the cells (hereinafter variously, referred to as a “lowest luminance”).

### CITATION LIST

### Patent Literature

[PTL 1] Japanese Unexamined Patent Application Publication No. 2012-63440

### SUMMARY OF INVENTION

### Technical Problem

A drawback in correcting the luminances of the cells to be the same as the lowest luminance is a reduction in overall brightness of a video displayed on a display panel.

The present disclosure provides a display unevenness correction apparatus, a display apparatus, a method for correcting display unevenness, and a method for manufacturing the display apparatus which can suppress a reduction in luminance which occurs in correcting luminance unevenness of a display panel.

### Solution to Problem

A display apparatus according to the present disclosure is a display unevenness correction apparatus for use in the manufacture of a display apparatus including a display panel having plural display pixels arranged in rows and columns, the display unevenness correction apparatus including: a luminance measurement unit configured to measure a luminance of the display panel while the display panel is being illuminated to obtain a luminance map indicating brightness at two-dimensional positions; a block luminance calculation unit configured to segment the luminance map into first blocks and calculate, for each of the first blocks, a block luminance of the first block using luminances included in the first block, the block luminance representing the luminances included in the first block; an interpolation unit configured to calculate a target luminance for each of the plural display pixels, using a corresponding one of the block luminances; and a correction coefficient calculation unit configured to calculate a correction coefficient for each of the plural display pixels so that a luminance of the display pixel approximates to the target luminance.

### Advantageous Effects of Invention

According to the display unevenness correction apparatus, the display apparatus, a method for correcting display unevenness, and the method for manufacturing the display apparatus of the present disclosure, a reduction in luminance which occurs in correcting the luminance unevenness of the display panel can be suppressed.

### BRIEF DESCRIPTION OF DRAWINGS

FIG. 1 is a graph depicting an example of luminance unevenness attributed to cell performance, for example.

FIG. 2 is a graph depicting an example of luminance unevenness attributed to backlights.

FIG. 3 is a graph depicting an example of luminance unevenness attributed to backlights.

FIG. 4 is a perspective view showing an example of a display unevenness correction apparatus and a display apparatus according to an embodiment.

FIG. 5 is a block diagram of an example of configuration of the display unevenness correction apparatus and the display apparatus according to the embodiment.

FIG. 6 is a perspective view of an example of configuration of an LCD display according to the embodiment.

FIG. 7 is a flowchart illustrating an example of procedure for a method of correcting the display unevenness according to the embodiment.

FIG. 8 is a diagram showing an example of block segmentation conducted on a luminance map, according to the embodiment.

FIG. 9 is a flowchart illustrating an example of procedure for calculating block luminances according to the embodiment.

FIG. 10 is a diagram showing an example of block segmentation conducted on the LCD panel, according to the embodiment.

FIG. 11 is a diagram illustrating an example of a method of calculating the target luminances of cells other than reference cells, according to the embodiment.

FIG. 12 is a graph depicting an example of a result of calculation of the target luminances according to an embodiment.

FIG. 13 is a diagram showing an example of paths of light output from backlights when an LCD panel is viewed from viewpoints 1 to 3 having different viewing angles.

FIG. 14 is a block diagram of an example of configuration of a display unevenness correction apparatus according to an embodiment.

### DESCRIPTION OF EMBODIMENTS

### Details of Problem

As described above, luminance unevenness includes the luminance unevenness attributed to cell performance or the like, and the luminance unevenness attributed to backlights.

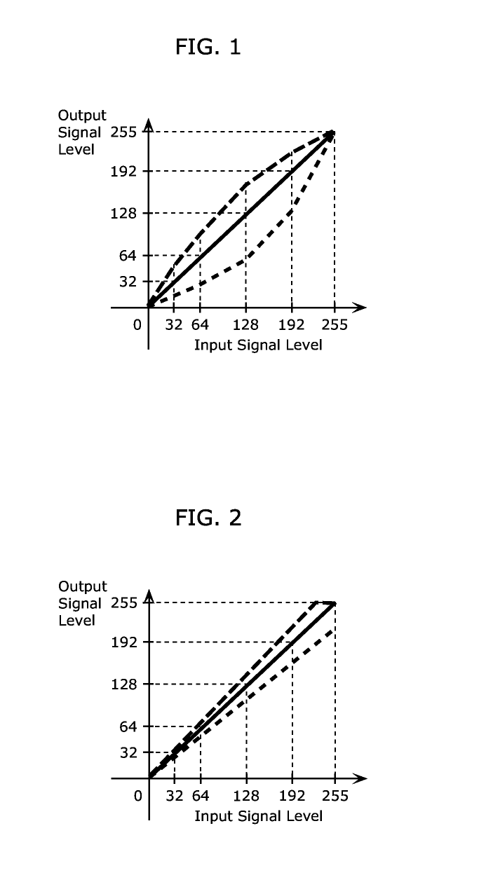

FIG. 1 is a graph depicting an example of luminance unevenness attributed to cell performance or the like. Luminance unevenness attributed to cell performance reduces towards low luminance and high luminance, while increasing in medium luminance.

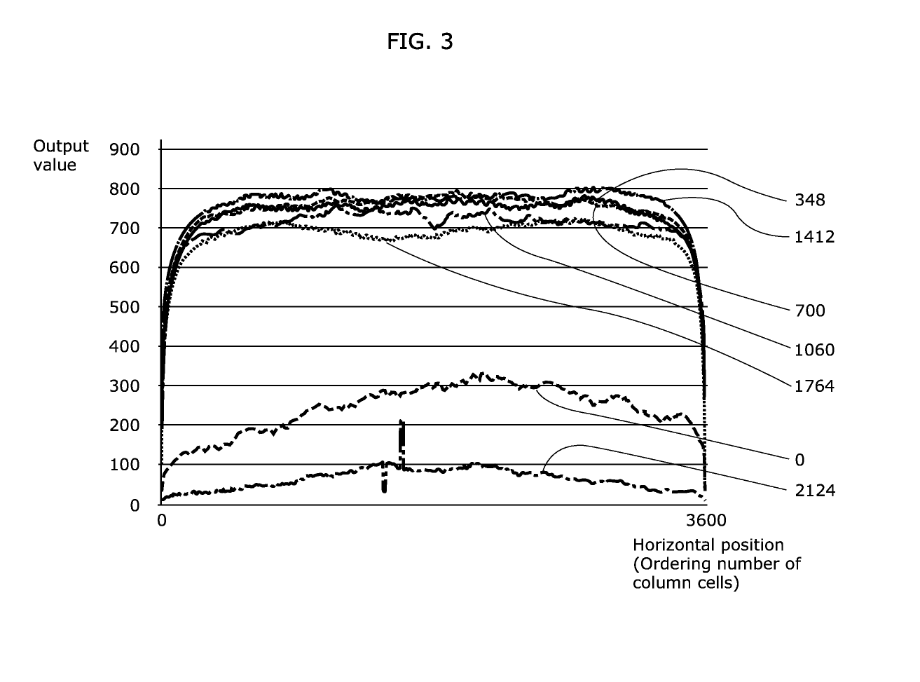

FIGS. 2 and 3 are graphs each showing an example of luminance unevenness attributed to backlights. FIG. 2 shows unevenness in luminance (output signal level) for each cell relative to a tonal value (input signal level). FIG. 3 shows relation between luminances and positions of the cells on the panel when the same tonal value is input to all the cells. Output values of a luminance meter 20 are indicated on the vertical axis of the graph shown in FIG. 3, indicating values corresponding to the luminances. Ordering numbers of column cells are indicated on the horizontal axis. The luminances are not uniform as shown in FIGS. 2 and 3. Also as shown in FIG. 3, even if the same tonal value is input to all the cells, the luminance significantly reduces, in particular, at the perimeter of the panel.

In recent years, displays have been made thinner, reducing a distance between the LCD panel and a diffuser and distances between the diffuser and backlights. Particularly in this case, the diffuser cannot sufficiently diffuse light from the backlights, and thus the luminance unevenness and color unevenness may appear strongly.

To correct such luminance unevenness, a display apparatus disclosed in Patent Literature (PTL) 1, for example, sets luminances of all display pixels to the same target luminance, according to a tonal value, and corrects a tonal value in each display pixel of a video signal according to a corresponding target luminance to approximate the luminance of the display pixel to the target luminance.

As to the luminance unevenness attributed to the backlights mentioned above, it has been found that a level of luminance unevenness varies in proportional to tonal values of a video signal input. Such luminance unevenness can be eliminated by, as with the display apparatus disclosed in PTL 1, setting luminances of all display pixels to the same target luminance, calculating correction gains so that luminance values of all the display pixels included in the display panel yield the target luminance, and multiplying the tonal values of the video signal by the correction gains.

The display apparatus disclosed in PTL 1, however, uses the lowest luminance as the target luminance to calculate the correction gains because, for example, if the tonal values of all the cells included in the video signal are set to the maximum tone, plus correction to increase the luminance cannot be performed. However, setting the target luminance to the lowest luminance significantly reduces the luminance of the display panel as described above.

Hereinafter, embodiments according to the present disclosure will be described in detail, with reference to the accompanying drawings. It should be noted that unnecessarily detailed description may be omitted. For example, detailed description of well-known matters or description previously set forth with respect to substantially the same configuration may be omitted. This is to avoid unnecessary redundancy in the description below and for facilitating an understanding by those skilled in the art.

The inventors provide the accompanying drawings and the description below for a thorough understanding of the present disclosure by those skilled in the art, and the accompanying drawings and the description are not intended to be limiting the subject matter recited in the claims appended hereto.

### Embodiment 1

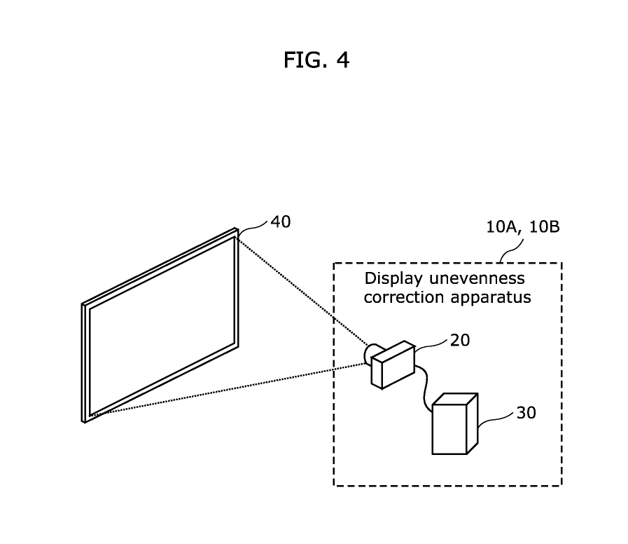

A display unevenness correction apparatus, a display apparatus, a method for correcting display unevenness, and a method for manufacturing the display apparatus according to an embodiment 1 will be described, with reference to FIGS. 4 through 12.

To suppress a significant reduction in luminance, the display unevenness correction apparatus according to the present embodiment calculates a block luminance for each block, rather than setting the target luminances to the lowest luminance across the display panel. The block luminance is a reference of the luminances in the block. The block luminance is used to calculate the target luminance for each display pixel.

### [1-1. Configuration]

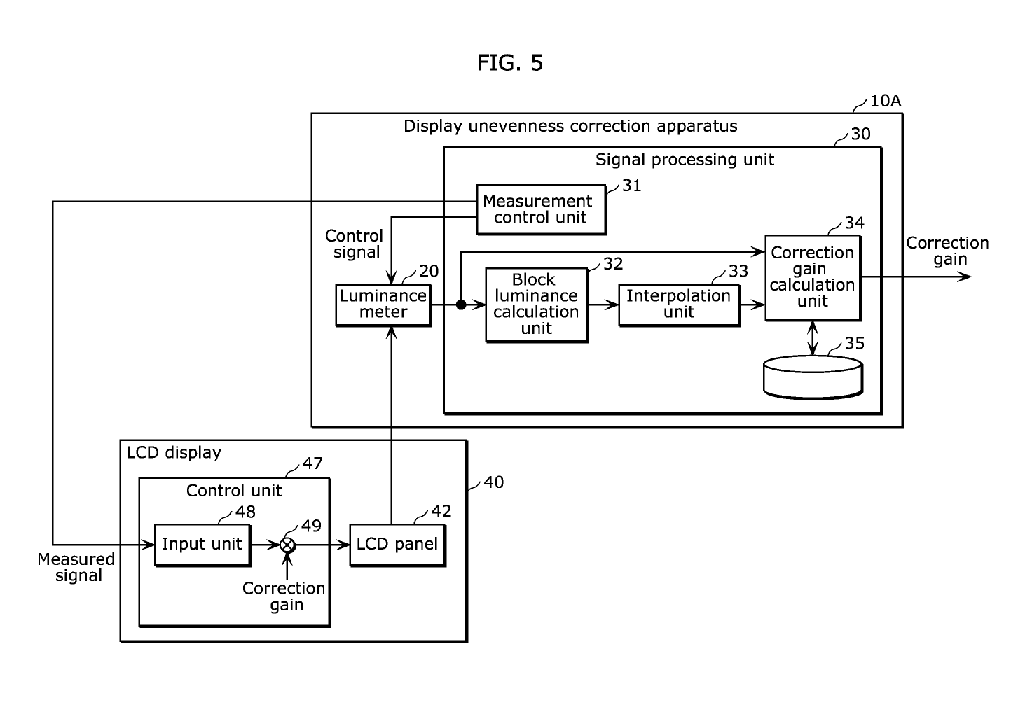

FIG. 4 is a perspective view showing an example of the display unevenness correction apparatus and the display apparatus according to the present embodiment. FIG. 5 is a block diagram of an example of configuration of the display unevenness correction apparatus and the display apparatus according to the present embodiment. As shown in FIG. 4, a display unevenness correction apparatus 10A includes the luminance meter 20 which measures luminance of the display apparatus, and a signal processing unit 30 which corrects display unevenness of the display apparatus.

### [1-1-1. Display Apparatus]

First, the configuration of the display apparatus, which is a target of correction of display unevenness in the present embodiment by the display unevenness correction apparatus 10A according to the present embodiment, will be described. The present embodiment will be described, with reference to an example where the display apparatus is an LCD display 40 and the display panel is an LCD panel.

It should be noted that the display apparatus is not limited to the LCD display 40. The display unevenness correction apparatus, the method for correcting display unevenness, etc. according to the present embodiment are useful for display apparatuses which cause the similar luminance unevenness attributed to backlights as shown in FIG. 2, that is, display apparatuses in which a level of luminance unevenness relative to tonal values appears as a line.

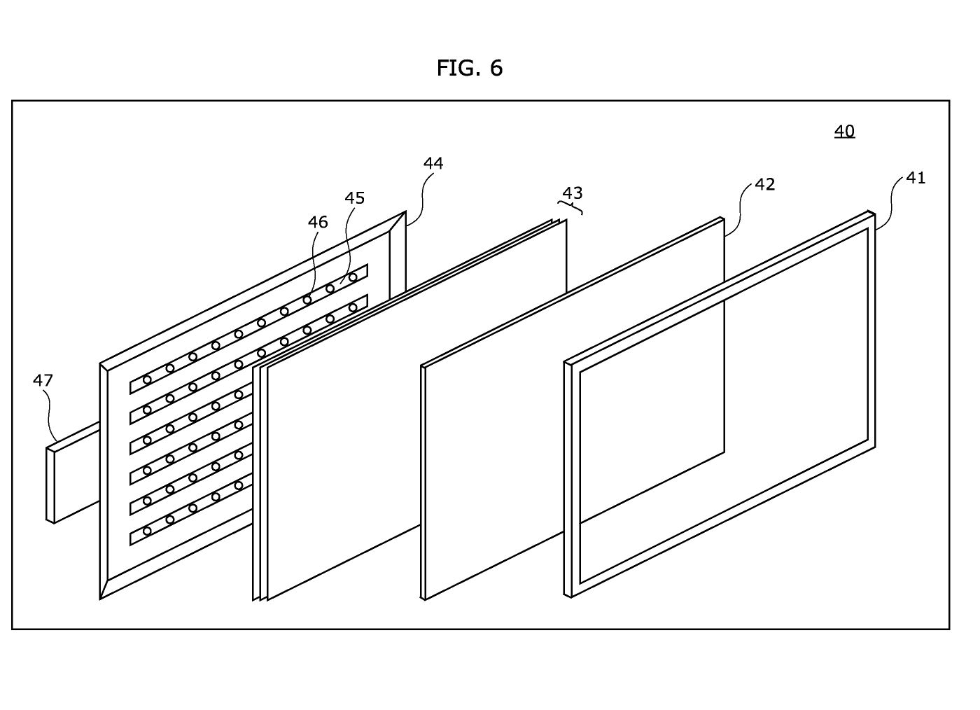

FIG. 6 is a perspective view of an example of configuration of the LCD display according to the present embodiment. The LCD display 40, more specifically, includes a front cabinet 41 which forms a front surface of a housing, an LCD panel 42, optical members 43, and a rear frame 44, as shown in FIG. 5.

In the LCD panel 42 a plurality of cells are arranged in rows and columns. The LCD panel 42 has a plurality of COFs (chip on film, chip on flexible) (not shown), which drive the cells, mounted thereon. COFs apply, to individual cells, signal voltages depending on data signals from a control unit 47. The LCD panel 42 is disposed, covering the opening of the front cabinet 41 from the backside. Transmittance of each cell included in the LCD panel 42 varies in response to the signal voltage applied to the cell. In other words, applying a signal voltage according to each tonal value of a video signal to each cell can vary transmittance of light of the cell. Varying the transmittance of light of each cell can change the luminance value of the cell.

The optical members 43 are disposed on the back of the LCD panel 42, and configured with a plural number of sheet-like members including a diffuser. The diffuser is a member which diffuses light from backlights 45. The diffuser is a flexible sheet-like member in the present embodiment.

The rear frame 44 is a member disposed on the back of the optical members 43, and includes the backlights 4. While the present embodiment will be described with reference to a case where the backlights 45 each include a plurality of LEDs 46, the backlights 45 are not limited thereto. The present embodiment will be described with reference to an example where the backlights 45 are direct-lit backlights. The backlights 45, however, may be edge-lit backlights. It should be noted that the direct-lit backlights and the edge-lit backlights yield different characteristics of luminance unevenness attributed to the arrangement of backlights. A reflector sheet for reflecting the light from the backlights 45 onto the LCD panel 42 is disposed on a portion of the rear frame 44 not covered by the backlights 45. As the backlights 45 are lit, the light output from the backlights 45 is diffused by the diffuser included in the optical members 43 and incident onto the LCD panel 42. The light output from the backlights 45 is made uniform to some extent by the diffuser.

The control unit 47 according to the present embodiment is configured with a timing controller (TCON). The control unit 47 functions as an input unit 48 and a correction unit 49, as shown in FIG. 5.

The input unit 48 receives a video signal input thereto from an external device. The input unit 48 processes an image indicated by the video signal, including resizing, correcting the image quality, etc. The image is formed of a plurality of pixels arranged in rows and columns. The resizing reduces or increases a size (e.g., the number of pixels and the aspect ratio) of the image indicated by the video signal, according to a size (e.g., the number of cells and the aspect ratio) of the LCD panel 42. If the size of the image indicated by the video signal and the size of the LCD panel 42 are the same, this processing may be omitted. The image-quality correction is processing to show an image displayed on the LCD display 40 clearly (at high video quality) and in a user-friendly way. The image-quality correction includes contour correction and gamut conversion, for example. It should be noted that the input unit 48 may be configured to perform further processing.

The correction unit 49 corrects tonal values of individual pixels output from the input unit 48. The correction unit 49 outputs values obtained by multiplying a tonal value of each cell by a correction gain corresponding to the cell calculated by the display unevenness correction apparatus 10A. For the calculation of the correction gain by the display unevenness correction apparatus 10A, the correction unit 49 sets the correction gain to 1 to output an input tonal value as is to the LCD panel 42.

### [1-1-2. Display Unevenness Correction Apparatus]

The display unevenness correction apparatus 10A calculates the correction gains for correcting the display unevenness of the display apparatus, and includes the luminance meter 20 and the signal processing unit 30, as shown in FIGS. 4 and 5.

### [1-1-3. Luminance Meter (Imaging Unit)]

The luminance meter 20 is by way of example of a luminance measurement unit which measures the luminance of the display panel. The luminance meter 20 measures luminance of a display screen of the LCD panel 42. The luminance meter 20 generates a luminance map indicating brightness at two-dimensional positions as measurement of the luminance. The luminance map is represented by two-dimensional image data, for example. The luminance meter 20 outputs the luminance map to the signal processing unit 30.

While the present embodiment will be described with reference to an example where the luminance measurement unit is the luminance meter 20, it should be noted that the luminance measurement unit may be any other device such as a CCD (charge coupled devices) camera. The CCD camera includes a plurality of receiving units which output electric signals having amplitude that depends on the intensity (luminance) of incident light.

Preferably, the resolution of the luminance measurement unit is equal to or greater than the number of cells of the LCD panel 42. However, the resolution of the luminance measurement unit may be lower than the number of cells of the LCD panel 42 because the measurement of the luminance obtained by the luminance measurement unit is used to calculate the block luminances.

In the case where a line sensor or the like is used as the luminance measurement unit, for example, the luminance measurement unit may create the luminance map by conducting measurement for a plural number of times.

### [1-1-4. Signal Processing Unit]

The signal processing unit 30 may be implemented in a computer system which includes, for example, a memory 35 such as a microprocessor, a random access memory (RAM), and a read only memory (ROM). Alternatively, the signal processing unit 30 may be configured with one or more system LSIs (Large Scale Integration).

The signal processing unit 30 includes a measurement control unit 31, a block luminance calculation unit 32, an interpolation unit 33, a correction gain calculation unit 34, and the memory 35.

The measurement control unit 31 outputs to the LCD display 40 a measurement video signal (hereinafter, referred to as a “measurement signal”) in which all the cells of the LCD panel 42 have a same tonal value, to display a test image on the LCD panel 42. After displaying the test image on the LCD panel 42, the measurement control unit 31 outputs to the luminance meter 20 a control signal for causing the luminance meter 20 to measure the luminance of the LCD panel 42.

The block luminance calculation unit 32 segments the luminance map output from the luminance meter 20 into first blocks, and calculates a block luminance for each first block, which is luminance representing the first block, using luminances included in the first block.

The interpolation unit 33 calculates the target luminance for each of the cells, using a corresponding block luminance.

The correction gain calculation unit 34 is by way of example of a correction coefficient calculation unit which calculates a correction coefficient for each of the cells so that the luminance of the cell approximates to the corresponding target luminance. The correction gain calculation unit 34 calculates, as a correction gain, a ratio between the target luminance and measurement of the luminance of each display pixel obtained from the luminance map.

As described above, the memory 35 is configured with a RAM and a ROM, for example. The memory 35 stores a computer program which includes steps of the method for correcting the display unevenness, various parameters for use in executing the method for correcting the display unevenness, the luminance map output from the luminance meter 20, results of calculation of the correction gains, etc.

### [1-2. Operation of Display Unevenness Correction Apparatus (Method for Correcting Display Unevenness, and Method for Manufacturing Display Apparatus)]

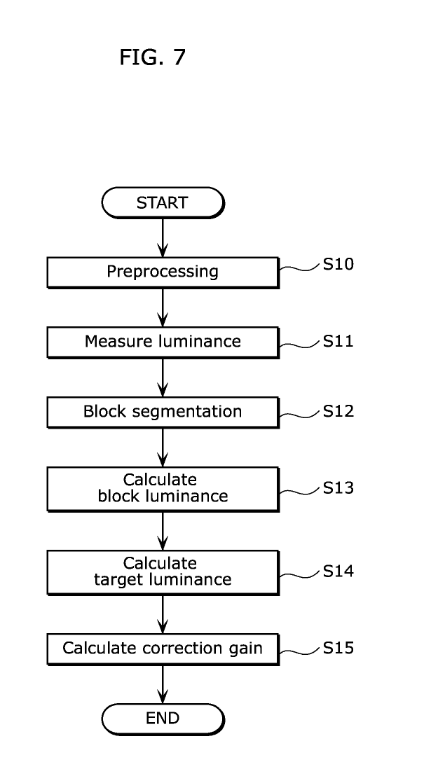

FIG. 7 is a flowchart illustrating an example of procedure for the method for correcting the display unevenness according to the present embodiment.

As shown in FIG. 2, the luminance unevenness attributed to the backlights varies by a constant gain, depending on luminance. Due to this, a same correction coefficient is allowed to be used for all tonal values when correcting the luminance unevenness attributed to the backlights. Specifically, the measurement control unit 31, the block luminance calculation unit 32, the interpolation unit 33, and the correction gain calculation unit 34 execute the method for correcting display unevenness for specific test tonal values, rather than for all the tonal values.

To initiate the correction of luminance unevenness, the signal processing unit 30 undoes gamma correction which adjusts luminance values of mid-tones of the LCD panel 42 (S10).

### [1-2-1. Measurement of Luminance]

The signal processing unit 30 measures the luminance of the LCD panel 42 by the luminance meter 20 (S11). The measurement control unit 31 outputs to the LCD display 40 a measurement signal in which the tonal values of all the cells described above are set to the same value. In correcting the luminance unevenness, the input unit 48 of the LCD display 40 does not perform signal processing which changes an input signal level, or otherwise performs signal processing which maintains the signal level. This displays the test image having luminance unevenness on the LCD panel 42.

The luminance meter 20 measures luminance of the test image displayed on the LCD panel 42 and outputs a luminance map as measurement of the luminance to the block luminance calculation unit 32.

### [1-2-2. Block Segmentation]

The block luminance calculation unit 32 segments the luminance map output from the luminance meter 20 into first blocks (S12). The luminance map is segmented horizontally and vertically.

Here, the block luminance calculation unit 32 and the interpolation unit 33 described below conduct block segmentation in a same manner. Specifically, the number and arrangement of first blocks and the number and arrangement of second blocks are the same. The first blocks are obtained by the block luminance calculation unit 32 segmenting the luminance map. The second blocks are obtained by the interpolation unit 33 segmenting the cells of the LCD panel 42.

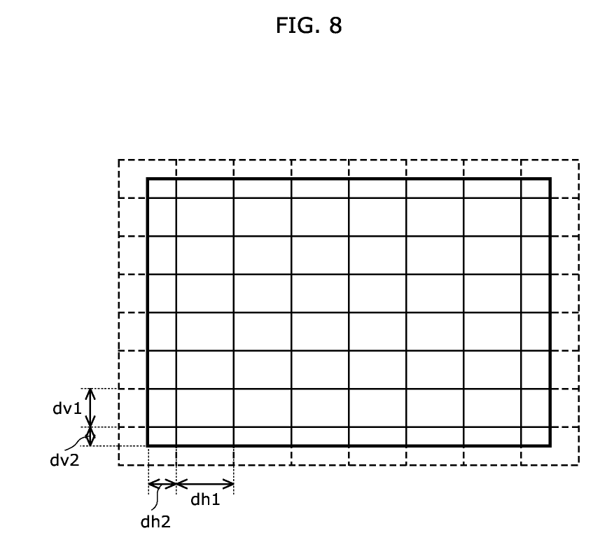

FIG. 8 is a diagram showing an example of the block segmentation conducted on the luminance map, according to the present embodiment. In FIG. 8, the luminance map is indicated by the bold line. The solid lines indicate boundaries between the first blocks.

The interpolation unit 33, described below, sets the target luminance of the cell in the center of each second block (hereinafter variously, referred to as a “reference cell”) to the block luminance, and determines target luminances of the other cells in the second block using the target luminance of the reference cell. Thus, the interpolation unit 33 performs the block segmentation in a manner that one of the cells at the edges of the LCD panel 42 in the second block is the reference cell in the present embodiment.

It should be noted that the reference cell may not necessarily be a pixel in the center of each second block. The reference cell may be a cell at a corner of the second block or may be any other cell. However, preferably, the reference cells are arranged in a matrix because the interpolation unit 33, described below, performs linear interpolation.

In FIG. 8, a block at the perimeter of the LCD panel 42 plus a portion represented by a dotted line have a same size as the other blocks. Specifically, the block luminance calculation unit 32 performs the block segmentation on a test pixel so that all blocks, including a block plus a portion represented by the dotted line, have a same size. In FIG. 8, a space dh2 is half the space dh1, and a space dv2 is half the space dv1.

If diffusion of light from direct-lit backlights is not sufficient as shown in FIG. 3 due to the luminance unevenness attributed to the backlights, the luminances at the edges of the panel, unlike that in the center of the panel, are likely to reduce. Additionally, the edges of the LCD panel 42 receive little user attention when the user is seeing the display. Thus, it is useful to reduce sizes of the first blocks at the perimeter of the LCD panel 42 as shown in FIG. 8. The first blocks at the perimeter may be subjected to special processing in calculating the block luminances or in calculating the target luminances.

The present embodiment will be described with reference to a case where the first blocks at the perimeter of the LCD panel 42 have small sizes. However the present disclosure is not limited thereto. All the blocks may have a uniform size.

Moreover, if the LCD display 40 employs edge-lit backlights rather than direct-lit backlights, luminance in the center portion of the LCD display 40 may be dark. Thus, any other segmentation method may be employed, such as reducing sizes of the first blocks that are at the perimeter and in the center portion of the LCD display 40. Any segmentation method may be employed according to configuration of the backlights of the LCD display 40.

It should be noted that the number of splits of the first block is appropriately determined depending on a size of the LCD panel 42.

### [1-2-3. Block Luminance Calculation]

The block luminance calculation unit 32 calculates a block luminance for each first block (S13). In the present embodiment, a minimum value of the luminances in the first block is obtained as the block luminance. It should be noted that the block luminance may be one other than the minimum value, such as an average value or a mean value, a value obtained by obtaining a curve from the luminances in the first block, etc. However, preferably, the block luminance is other than a maximum value.

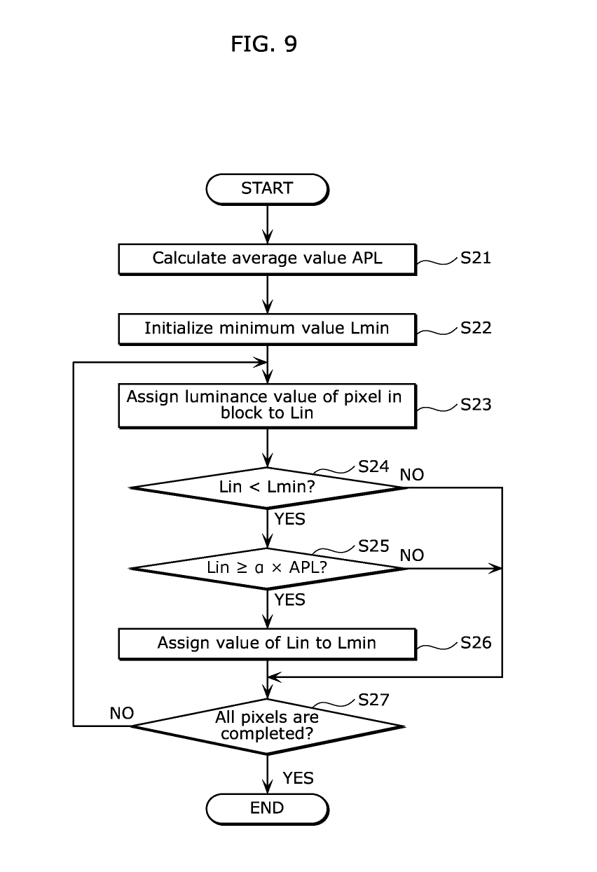

FIG. 9 is a flowchart illustrating an example of procedure for calculating the block luminances according to the present embodiment. It should be noted that the luminance map may have regions which yield abnormal values indicating significantly low luminance due to a fact that some of the cells included in the LCD panel 42 are unilluminated. Thus, the block luminance calculation unit 32 according to the present embodiment is configured not to set the block luminance to a luminance unsuitable for the block luminance, such as the abnormal value.

The block luminance calculation unit 32, first, calculates an average value APL of the luminances in each first block to obtain a determined value for determining a luminance unsuitable for the block luminance of the first block (S21). The block luminance calculation unit 32 sets the determined value to a value obtained by multiplying APL by a coefficient a. The coefficient a can be set according to characteristics of the panel. The coefficient a is a constant, for example, 0.9, 0.95, etc., including numeric values on the right of the decimal point.

The average value APL is obtained by the following equation: APL=(a sum of the luminance data items per block/the number of pixels in the block) (Equation 1).

The block luminance calculation unit 32 initializes a minimum value Lmin (S22). The block luminance calculation unit 32 assigns, to a default value of the minimum value Lmin, a value greater than or equal to a maximum value (a measured or theoretical value) of the luminances or a value of the first pixel of the first block.

The block luminance calculation unit 32 assigns a luminance value of a pixel that has not been subjected to the processing to a variable Lin (S23).

The block luminance calculation unit 32 compares the variable Lin with the minimum value Lmin (S24).

If the variable Lin is greater than or equal to the current minimum value Lmin (NO in S24), the block luminance calculation unit 32 proceeds to step S27.

If the variable Lin is less than the current minimum value Lmin (YES in S24), the block luminance calculation unit 32 compares the variable Lin with APL x a (S25).

If the variable Lin is less than APL x a (NO in S25), the block luminance calculation unit 32 determines that the variable Lin is abnormal value data. The block luminance calculation unit 32 proceeds to step S27, without assigning the value of the variable Lin to the minimum value Lmin.

If the variable Lin is greater than or equal to APL x a (YES in S25), the block luminance calculation unit 32 determines that the variable Lin is a normal value. Subsequently, the block luminance calculation unit 32 assigns the value of the variable Lin to the minimum value Lmin (S26).

The block luminance calculation unit 32 repeats steps S23 through S26 for the number of all the pixel values (S27).

The block luminance calculation unit 32 calculates the above-mentioned minimum values Lmin for all the first blocks. The block luminance calculation unit 32 sets the block luminances of the corresponding first blocks to the calculated minimum values Lmin. The block luminance calculation unit 32 outputs the block luminance of every first block to the interpolation unit 33.

### [1-2-4. Target Luminance Calculation]

The interpolation unit 33 calculates a target luminance of each of the cells of the LCD panel 42, as illustrated in FIG. 7 (S14).

The interpolation unit 33, first, segments the cells included in the LCD panel 42 into second blocks. A method of the block segmentation is the same as the method of segmenting the luminance map described with reference to step S12.

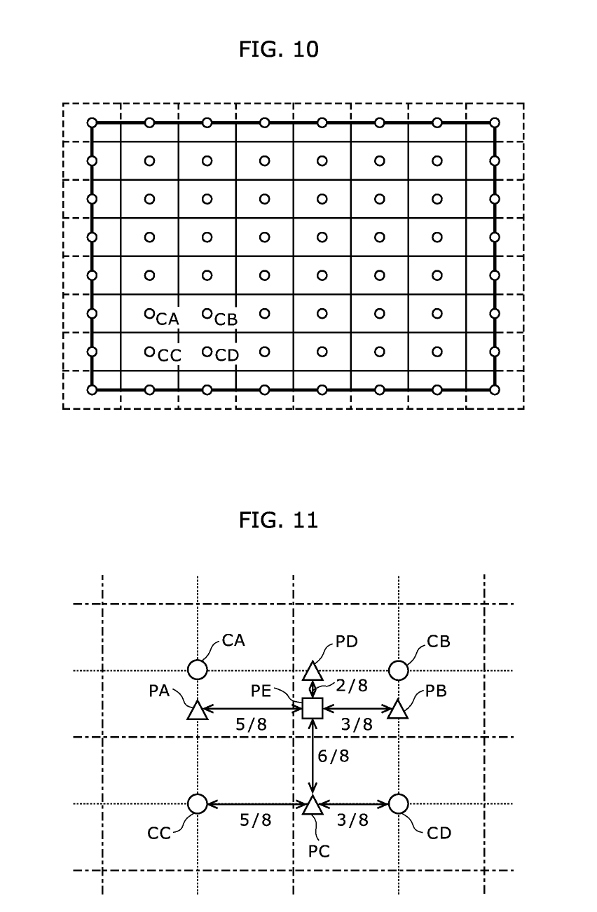

FIG. 10 is a diagram showing an example of the block segmentation conducted on the LCD panel 42, according to the present embodiment. In FIG. 10, a display region of the LCD panel 42 is indicated by the bold line. The solid lines indicate boundaries between the second blocks.

The interpolation unit 33 sets the target luminances of reference cells each in the center of a corresponding second block to block luminances output from the block luminance calculation unit 32.

Subsequently, the interpolation unit 33 generates target luminances of cells other than the reference cells in the second block. In the present embodiment, the interpolation unit 33 performs the linear interpolation to determine the target luminances of the cells other than the reference cells so that the target luminances smoothly changes between reference cells. For calculation of a target luminance, the interpolation unit 33 uses the target luminance values of two or four reference cells surrounding a cell whose target luminance is to be calculated (hereinafter, referred to as a “cell to be calculated”). The method of determining the target luminances of cells other than the reference cells is not limited to the linear interpolation. The target luminances of the cells other than the reference cells may be calculated by, for example, obtaining a curve of any luminance value from the target luminances of the reference cells.

FIG. 11 is a diagram illustrating an example of the method of calculating the target luminances of cells other than the reference cells according to the present embodiment. In FIG. 11, cells CA, CB, CC, CD indicated by circles are reference cells, and they are each in the center of a corresponding second block indicated by a dot-dashed line. The fractions in FIG. 11 indicate relative values of distances when the vertical or horizontal length of each second block is 1. It should be noted that the fractions in FIG. 11 are represented in terms of a so-called distance ratio. Thus, the same numeric value in the vertical and horizontal directions may not yield the same distance when the vertical and horizontal lengths of the second block are different.

The interpolation unit 33 uses target luminance values of two or four reference cells, and a distance between each of the reference cells used and a cell to be calculated. For each of the reference cells used, the interpolation unit 33 multiplies a value of the reference cell by a weighting coefficient according to the distance between the reference cell and the cell to be calculated, and adds the values obtained from the multiplication made for each of the reference cells.

Specifically, for example, the interpolation unit 33 performs two-point interpolation if the cell to be calculated, such as cells PA, PB, PC, and PD (cells indicated by triangles) shown in FIG. 11, is on a line extending between two reference cells. The target luminance of PX is obtained by an expression: the target luminance of CX1×a weighting coefficient A1+the target luminance of CX2×a weighting coefficient A2, where PX represents the cell to be calculated, and CX1 and CX2 represent the reference cells to be used. The weighting coefficient A1 is obtained by an expression: (the distance between CX2 and PX/the distance between CX1 and CX2). The weighting coefficient A2 is obtained by an expression: (the distance between CX1 and PX/the distance between CX1 and CX2).

In FIG. 11, for example, the target luminance value of the cell PC to be calculated is obtained by an expression: the target luminance of CC×⅜+the target luminance of CD×⅝.

For example, the interpolation unit 33 performs four-point interpolation if the cell to be calculated, such as a cell PE (cells indicated by squares) shown in FIG. 11, is at a position other than on a line extending between two reference cells. PX represents the cell to be calculated and CX1 to CX4 represent the reference cells to be used. Consider that the reference cells CX1 and CX2 are in a same cell row, and CX3 and CX4 in a same cell row. Furthermore, consider that the reference cells CX1 and CX3 are in a same cell column, and CX2 and CX4 are in a same cell column.

In this case, the target luminance of the cell PX to be calculated is obtained by an expression: (the target luminance of CX1×the weighting coefficient A1+the target luminance of CX2×the weighting coefficient A2)×a weighting coefficient B1+(the target luminance of CX3×the weighting coefficient A1 +the target luminance of CX4×the weighting coefficient A2)×a weighting coefficient B2.

The weighting coefficient A1 is obtained by an expression: (the distance between CX2 and PX/the distance between CX1 and CX2). It should be noted that the weighting coefficient Al has the same value as one obtained by an expression: (the distance between CX4 and PX/the distance between CX3 and CX4). The weighting coefficient A2 is obtained by an expression: (the distance between CX1 and PX/the distance between CX1 and CX2). It should be noted that the weighting coefficient A2 has the same value as one obtained by an expression: (the distance between CX3 and PX/the distance between CX3 and CX4).

The weighting coefficient B1 is obtained by an expression: the distance between CX3 and PX/the distance between CX1 and CX3. The weighting coefficient B2 is obtained by an expression: the distance between CX1 and PX/the distance between CX1 and CX3.

In FIG. 11, a target luminance value of the cell PE to be calculated is obtained by an expression: ((the target luminance of PA×⅜+the target luminance of PB×5)× 6/8)+((the target luminance of C×⅜+the target luminance of D×⅝) × 2/8.

Accordingly, the interpolation unit 33 calculates the target luminance for each of the cells included in the LCD panel 42. The interpolation unit 33 outputs the plurality of target luminances calculated, to the correction gain calculation unit 34.

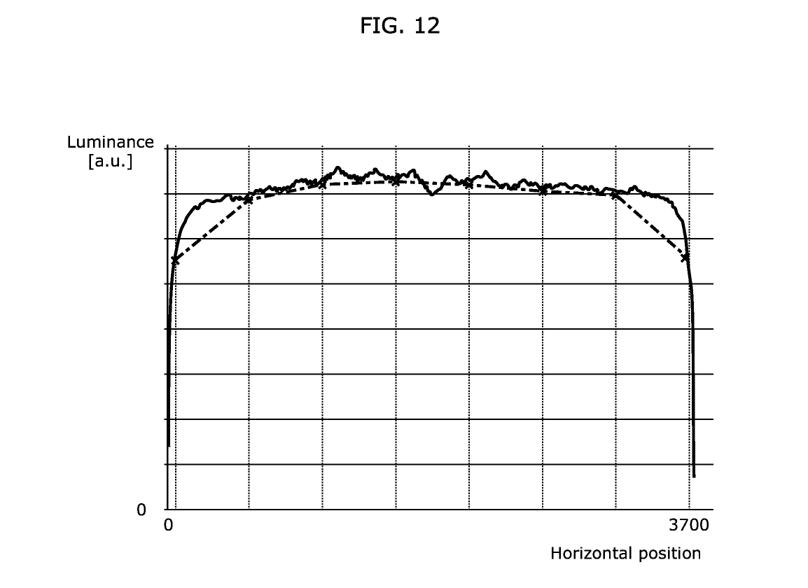

FIG. 12 is a graph depicting an example of a result of calculation of the target luminances according to the present embodiment. In FIG. 12, the solid line corresponds to luminance values in 1060th row shown in FIG. 3. In FIG. 12, the dot-dashed line shows a result of calculation of the target luminances. As shown in FIG. 12, the target luminances indicated by the dot-dashed line smoothly change. Correcting the luminance of the LCD panel 42 to be the target luminance, accordingly, suppresses luminance unevenness appeared when a user sees the LCD panel 42 from outside, thereby suppressing degradation in video quality.

### [1-2-5. Calculation of Correction Gain (i.e., Correction Coefficient)]

The correction gain calculation unit 34, as shown in FIG. 7, calculates correction gains for the cells included in the LCD panel 42 (S15), using the target luminances calculated in step S14.

The correction gain is obtained by raising (the target luminance/measurement of the luminance of a corresponding cell by the luminance meter 20) to a power of 1/y.

Here, if the resolution of the luminance meter 20 is greater or is lower than the resolution of the LCD panel 42, the correction gain calculation unit 34 resizes the luminance map output from the luminance meter 20 to the size of the LCD panel 42 to obtain the measurement of the luminance (measured luminance) of the corresponding cell by the luminance meter 20. If the resolution of the luminance meter 20 is the same as the resolution of the LCD panel 42, the luminance map is used as is for the measurement of the luminance of the corresponding cell by the luminance meter 20.

If the resolution of the luminance meter 20 is lower than the resolution of the LCD panel 42, the correction gain calculation unit 34 enlarges the luminance map. The correction gain calculation unit 34 arranges interpolated pixels between pixels in the luminance map, according to an enlargement ratio. The correction gain calculation unit 34 calculates a luminance value of each interpolated pixel through linear interpolation so that generated data linearly changes between luminance values of test pixels vertically and horizontally adjacent to the interpolated pixel. At this time, an interpolated pixel at the top, bottom, left, or right end of the luminance map may not have an adjacent pixel. Values of the interpolated pixels are determined so as not to be abnormal values even if an adjacent pixel is absent. A luminance value of a test pixel used may be a luminance value of one pixel that is vertically and horizontally adjacent to the interpolated pixel, and, alternatively, luminance values of a plurality of pixels may be used for the interpolation.

While the luminance map is enlarged by the correction gain calculation unit 34 in the present embodiment, it should be noted that the enlargement of the luminance map may be carried out by the interpolation unit 33. The pixels may be enlarged by bilinear, bicubic, etc., that is commonly used in enlarging pixels.

A value of (the target luminance/measurement of the luminance of a corresponding cell by the luminance meter 20) is raised to the power of 1/y to eliminate the effects of the gamma correction. In the present embodiment, since the gamma correction is undone during preprocessing (S10) in FIG. 7, the correction gain is calculated, wherein y=1.

### [1-3. Operation of Display Apparatus]

The correction gains calculated by the display unevenness correction apparatus 10A are written into a memory (not shown) of the LCD display 40.

The LCD display 40 enables the gamma correction to display the video signal. The input unit 48, for example, resizes and performs the above-mentioned image-quality correction on the input video signal. The correction unit 49 multiplies each of tonal values of a plurality of cells indicated by the video signal output from the input unit 48 by a corresponding correction gain.

At this time, for the purpose of further preventing the reduction in luminance value of the plurality of cells indicated by the video signal, if a correction gain is greater than threshold, the threshold, rather than the value calculated by the display unevenness correction apparatus 10A, may be used as the correction gain.

The LCD panel 42 displays a video according to the video signal output from the correction unit 49.

### [1-4. Effects]

In the display unevenness correction apparatus, the display apparatus, the method for correcting display unevenness, and the method for manufacturing the display apparatus according to the present embodiment, the block luminance for each of the first blocks obtained by conducting the block segmentation on the luminance map is calculated and the block luminance is used to calculate the target luminance of each of the cells in the first block, as described above. This allows suppression of prominent, minute luminance unevenness in the display unevenness correction apparatus, the display apparatus, the method for correcting display unevenness, and the method for manufacturing the display apparatus according to the present embodiment. Furthermore, according to the display unevenness correction apparatus, the display apparatus, the method for correcting display unevenness, and the method for manufacturing the display apparatus of the present embodiment, a reduction in luminance of an image displayed on the LCD panel 42 can be suppressed as compared with a case where the target luminances of all the cells are set to the lowest luminance across the display panel. In the display unevenness correction apparatus, the display apparatus, the method for correcting display unevenness, and the method for manufacturing the display apparatus according to the present embodiment, in particular, an unnecessary reduction in luminance can be mitigated in regions under the influence of regions where the luminances are significantly low at the perimeter of the LCD panel 42.

Furthermore, in the display unevenness correction apparatus, the display apparatus, the method for correcting display unevenness, and the method for manufacturing the display apparatus according to the present embodiment, the block luminance is set to a value other than the maximum value, e.g., a minimum value of the luminances in the first block, thereby accommodating the luminance unevenness only by a minus correction of reducing tonal values. For example, the correction of luminance unevenness is allowed even if the tonal values of all the cells included in the video signal (the luminance correction is still allowed when the tonal value cannot be increased) is set to the maximum tone.

In the display unevenness correction apparatus, the display apparatus, the method for correcting display unevenness, and the method for manufacturing the display apparatus according to the present embodiment, luminance unevenness is accommodated only by the minus correction, and tonal values indicated by the video signal are multiplied by correction gains, thereby allowing accommodation of luminance unevenness in various display panels.

It should be noted that in the display unevenness correction apparatus, the display apparatus, the method for correcting display unevenness, and the method for manufacturing the display apparatus according to the present embodiment, target luminance for each of the cells is calculated to calculate a correction gain so that the correction gain approximates to the target luminance. Thus, luminance unevenness is not completely removed. However, smooth change in luminance in a large range is less likely to be recognized as luminance unevenness to a user. In the display unevenness correction apparatus, the display apparatus, the method for correcting display unevenness, and the method for manufacturing the display apparatus according to the present embodiment, luminance unevenness can be corrected to an extent that is unrecognizable to the user viewing the LCD display 40. In other words, in the display unevenness correction apparatus, the display apparatus, the method for correcting display unevenness, and the method for manufacturing the display apparatus according to the present embodiment, the user cannot recognize luminance unevenness and thus video quality as high as completely removing the luminance unevenness may be achieved.

### Embodiment 2

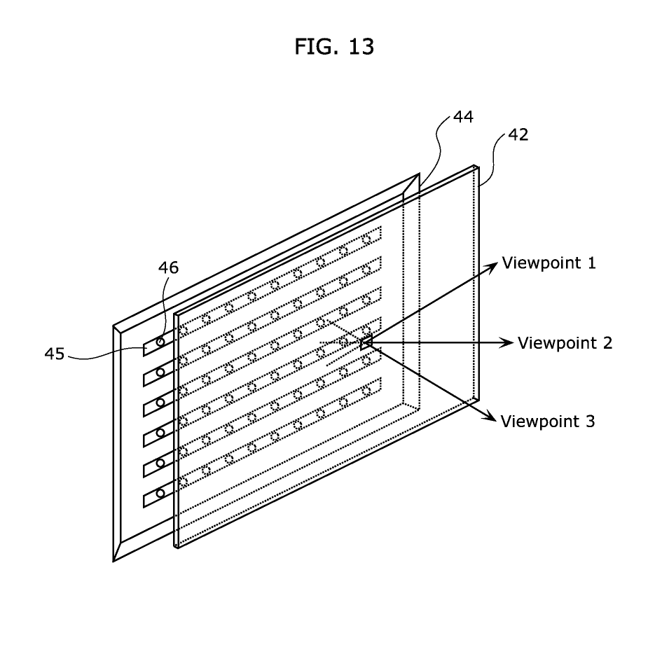

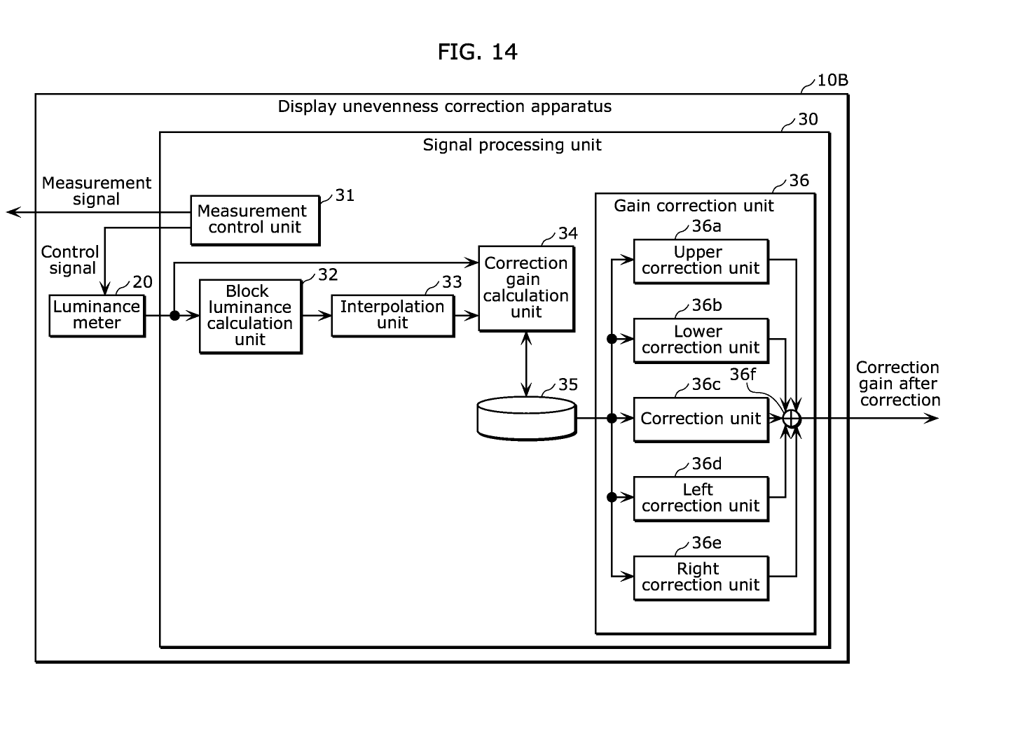

A display unevenness correction apparatus, a display apparatus, a method for correcting display unevenness, and a method for manufacturing the display apparatus according to an embodiment 2 will be described, with reference to FIGS. 13 and 14.

In the present embodiment, the correction gains calculated in the embodiment 1 are further corrected to correct changes in appearance of luminance unevenness depending on a viewing angle.

Here, a change in angle at which an LCD panel 42 is seen (hereinafter variously, referred to as a “viewing angle”) changes a path of light output from backlights 45, thereby chancing an amount of light blocked by liquid crystal. Thus, the change in viewing angle may end up shifting the appearance of the luminance unevenness attributed to the backlights 45 vertically or horizontally, or changing the intensity.

Hence, in the present embodiment, as described above, the correction gains calculated in the embodiment 1 are further corrected to correct a change in appearance of luminance unevenness depending on a viewing angle, thereby mitigating the change in appearance of luminance unevenness depending on a viewing angle.

FIG. 13 is a diagram showing an example of paths of light output from the backlights 45 when the LCD panel 42 is viewed from viewpoints 1 to 3 having different viewing angles. In the following, correction of correction gains to mitigate the change in appearance of luminance unevenness depending on a viewing angle will be described.

### [2-1. Configuration]

The display apparatus according to the present embodiment has the same configuration as the embodiment 1. In the present embodiment, as with the embodiment 1, description will be given with reference to an example where the display apparatus is the LCD display 40.

FIG. 14 is a block diagram of an example of configuration of the display unevenness correction apparatus according to the present embodiment.

A display unevenness correction apparatus 10B is, as with the embodiment 1, an apparatus which calculates correction gains for correcting display unevenness of a display apparatus, and includes a luminance meter 20 and a signal processing unit 30, as shown in FIG. 14.

The luminance meter 20 has the same configuration as the embodiment 1.

The signal processing unit 30 includes a measurement control unit 31, a block luminance calculation unit 32, an interpolation unit 33, a correction gain calculation unit 34, a memory 35, and a gain correction unit 36. The measurement control unit 31, the block luminance calculation unit 32, the interpolation unit 33, and the correction gain calculation unit 34 have the same configuration as the embodiment 1. The correction gain calculation unit 34 stores correction gains into the memory 35.

The gain correction unit 36 includes an upper correction unit 36a, a lower correction unit 36b, a correction unit 36c, a left correction unit 36d, a right correction unit 36e, and an adder 36f.

The upper correction unit 36a obtains a correction gain of a cell (hereinafter, referred to as an “above-neighboring cell”) adjacent atop of a cell to be corrected, from a result of calculation of the correction gains stored in the memory 35.

The upper correction unit 36a outputs to the adder 36f a value Ga obtained by multiplying the correction gain of the above-neighboring cell by a coefficient Ca.

The lower correction unit 36b obtains a correction gain of a cell (hereinafter, referred to as a “lower-neighboring cell”) adjacent to the bottom of the cell to be corrected, from a result of calculation of the correction gains stored in the memory 35. The lower correction unit 36b outputs to the adder 36f a value Gb obtained by multiplying the correction gain of the lower-neighboring cell by a coefficient Cb.

The correction unit 36c obtains a correction gain of the cell to be corrected, from a result of calculation of the correction gains stored in the memory 35 to output a value Gc obtained by multiplying the correction gain of the cell to be corrected by a coefficient Cc to the adder 36f.

The left correction unit 36d obtains a correction gain of a cell (hereinafter, referred to as a “left-neighboring cell”) adjacent to the left of the cell to be corrected, from a result of calculation of the correction gains stored in the memory 35. The left correction unit 36d outputs to the adder 36f a value Gd obtained by multiplying the correction gain of the left-neighboring cell by a coefficient Cd.

The right correction unit 36e obtains a correction gain of a cell (hereinafter, referred to as a “right-neighboring cell”) adjacent to the right of the cell to be corrected, from a result of calculation of the correction gains stored in the memory 35.

The right correction unit 36e outputs to the adder 36f a value Ge obtained by multiplying the correction gain of the right-neighboring cell by a coefficient Ce.

The adder 36f adds the coefficient, the values Ga, Gb, Gc, and Gd to the correction gain of the cell to be corrected to correct the correction gain of the cell. The adder 36f outputs a correction gain after the correction to the LCD display 40.

Here, the coefficients Ca to Ce are determined so that a sum of the coefficients is 1, e.g., let the coefficient Cc=0.6, and the coefficient Ca=Cb=Cd=Ce=0.1. The coefficient Cc is multiplied to the correction gain of the cell to be corrected, and thus set greater than the other coefficients. It should be noted that the way of determining the coefficients Ca to Ce is not limited thereto.

As described above, adding the correction gains of pixels surrounding the cell to be corrected to the correction gain of the cell to be corrected mitigates the change in appearance of luminance unevenness depending on a viewing angle.

While in the present embodiment the gain correction unit uses the correction gains of four cells horizontally and vertically adjacent to the cell to be corrected to correct the correction gain of the cell to be corrected, it should be noted that the present disclosure is not limited thereto. The gain correction unit 36 may use two correction gains of two left-neighboring cells adjacent to the cell to be corrected and two correction gains of right-neighboring cells adjacent to the cell to be corrected. Alternatively, the gain correction unit 36 may use correction gains of four cells vertically adjacent to the cell to be corrected. The gain correction unit 36 may use correction gains of eight cells surrounding the cell to be corrected. The number of cells and the correction gains of cells which are used in correcting the correction gain of the cell to be corrected can be determined according to characteristics of an image indicated by a video signal.

[2-2. Effects]

In the display unevenness correction apparatus, the display apparatus, the method for correcting display unevenness, and the method for manufacturing the display apparatus according to the present embodiment, as with the above embodiment 1, luminance unevenness can be corrected to an extent that is unrecognizable to the user and also a reduction in luminance can be reduced. Furthermore, in the display unevenness correction apparatus, the display apparatus, the method for correcting display unevenness, and the method for manufacturing the display apparatus according to the present embodiment, as with the above embodiment 1, the block luminance is set to a value other than a maximum value of luminances in a first block, e.g., a minimum value, thereby accommodating the luminance unevenness only by a minus correction of reducing tonal values in the first block.

Furthermore, in the display unevenness correction apparatus, the display apparatus, the method for correcting display unevenness, and the method for manufacturing the display apparatus according to the present embodiment luminance unevenness associated with a difference in viewing angle can be mitigated. Since the correction gains are further corrected, luminance unevenness when the LCD display 40 is viewed from a position corresponding to the luminance meter 20 is greatly suppressed by correcting the luminance unevenness using the correction gains before the correction, as compared with correcting the luminance unevenness using the correction gains obtained after the correction. However, luminance unevenness when the LCD display 40 is viewed at a different viewing angle greatly improves by correcting the luminance unevenness using the correction gains obtained after the correction, as compared with correcting the luminance unevenness using the correction gains before the correction. Considering the entirety of the LCD display 40, it is useful that the luminance unevenness can be reduced on average at various viewpoints.

### Other Embodiments

As the above, the embodiments have been described by way of example of the technology of the present disclosure. To this extent, the accompanying drawings and detailed description have been provided.

Thus, the components set forth in the accompanying drawings and detailed description include not only those essential to solve the problems but also those unnecessary to solve the problems but for illustration of the above implementations. Thus, those unnecessary components should not be acknowledged essential due to the mere fact that the unnecessary components are depicted in the accompanying drawings or set forth in the detailed description.

The above embodiments is for illustration of the technology of the present disclosure, and thus various modifications, permutations, additions, and omissions are possible in the scope of the appended claims and the equivalents thereof.

### INDUSTRIAL APPLICABILITY

The present disclosure is useful as technology for correcting luminance unevenness of display panels.

### REFERENCE SIGNS LIST

10A, 10B Display unevenness correction apparatus
20 Luminance meter
30 Signal processing unit
31 Measurement control unit
32 Block luminance calculation unit
33 Interpolation unit
34 Correction gain calculation unit
35 Memory
36 Gain correction unit
36a Upper correction unit
36b Lower correction unit
36c, 49 Correction unit
36d Left correction unit
36e Right correction unit
36f Adder
40 LCD display
41 Front cabinet
42 LCD panel
43 Optical member
44 Rear frame
45 Backlight
46 LED
47 Control unit
48 Input unit

1. A display unevenness correction apparatus for use in the manufacture of a display apparatus including a display panel having plural display pixels arranged in rows and columns, the display unevenness correction apparatus comprising:
a luminance measurement unit configured to measure a luminance of the display panel while the display panel is being illuminated to obtain a luminance map indicating brightness at two-dimensional positions;
a block luminance calculation unit configured to segment the luminance map into first blocks and calculate, for each of the first blocks, a block luminance of the first block using luminances included in the first block, the block luminance representing the luminances included in the first block;
an interpolation unit configured to calculate a target luminance for each of the plural display pixels, using a corresponding one of the block luminances; and
a correction coefficient calculation unit configured to calculate a correction coefficient for each of the plural display pixels so that a luminance of the display pixel approximates to the target luminance.

2. The display unevenness correction apparatus according to claim 1, wherein the correction coefficient calculation unit is further configured to correct the correction coefficient for a display pixel to be processed among the plural display pixels, using the target luminance of one or more of the plural display pixels adjacent to the display pixel to be processed.

3. The display unevenness correction apparatus according to claim 2, wherein
the one or more display pixels include display pixels on left and right of the display pixel to be processed.

4. The display unevenness correction apparatus according to claim 1, wherein
the block luminance calculation unit is configured to set the block luminance of a current block, whose block luminance is to be calculated, to a minimum value of luminances in the current block.

5. The display unevenness correction apparatus according to claim 4, wherein
the block luminance calculation unit is configured to select the block luminance of the current block from among luminances within a luminance range obtained from the luminances in the current block.

6. The display unevenness correction apparatus according to claim 1, wherein
the interpolation unit is configured to segment the plural display pixels into second blocks, and set a target luminance of a representative display pixel located in a center of each of the second blocks to the block luminance, the second blocks being of a same number and in same arrangement with the first blocks.

7. The display unevenness correction apparatus according to claim 6, wherein
the interpolation unit is configured to set the target luminance of a second block that includes a display pixel located at a perimeter of the display panel among the second blocks to a luminance of the display pixel.

8. The display unevenness correction apparatus according to claim 6, wherein
the interpolation unit is configured to calculate, for each of the plural display pixels other than the representative display pixel, the target luminance of the display pixel through linear interpolation, using the target luminances of two or more of the representative display pixels near the display pixel.

9. The display unevenness correction apparatus according to claim 1, wherein
the correction coefficient calculation unit is configured to, for each of the plural display pixels, calculate a measured luminance corresponding to the display pixel using the luminance map, and calculate a ratio of the target luminance of the display pixel to the measured luminance to obtain the correction coefficient.

10. A display apparatus which corrects tonal values of a signal input from outside, using correction coefficients calculated by the display unevenness correction apparatus according to claim 1.

11. A method for correcting display unevenness, executed by a display unevenness correction apparatus including a luminance measurement unit and a signal processing unit in the manufacture of a display apparatus including a display panel having plural display pixels arranged in rows and columns, the method comprising:
measuring, by the luminance measurement unit, a luminance of the display panel while the display panel is being illuminated to obtain a luminance map indicating brightness at two-dimensional positions;
segmenting, by the signal processing unit, the luminance map into first blocks and calculate, for each of the first blocks, a block luminance of the first block using luminances included in the first block, the block luminance representing the luminances included in the first block;
calculating, by the signal processing unit, a target luminance for each of the plural display pixels, using a corresponding one of the block luminances; and
calculating, by the signal processing unit, a correction coefficient for each of the plural display pixels so that a luminance of the display pixel approximates to the target luminance.

12. A method for manufacturing a display apparatus including a display panel having plural display pixels arranged in rows and columns, executed by a display unevenness correction apparatus including a luminance measurement unit and a signal processing unit, the method comprising:
measuring, by the luminance measurement unit, a luminance of the display panel while the display panel is being illuminated to obtain a luminance map indicating brightness at two-dimensional positions;
segmenting, by the signal processing unit, the luminance map into first blocks and calculate, for each of the first blocks, a block luminance of the first block using luminances included in the first block, the block luminance representing the luminances included in the first block;
calculating, by the signal processing unit, a target luminance for each of the plural display pixels, using a corresponding one of the block luminances; and
calculating, by the signal processing unit, a correction coefficient for each of the plural display pixels so that a luminance of the display pixel approximates to the target luminance.
